(19) United States
(12) Patent Application Publication
(10) Pub. No.: US 2025/0163723 A1
(43) Pub. Date: May 22, 2025

(54) A FENCE POST

(71) Applicant: GALLAGHER GROUP LIMITED, Hamilton (NZ)

(72) Inventor: Robert Andrew Wade, Hamilton (NZ)

(73) Assignee: GALLAGHER GROUP LIMITED, Hamilton (NZ)

(21) Appl. No.: 18/839,357

(22) PCT Filed: Feb. 17, 2023
(86) PCT No.: PCT/NZ2023/050014

§ 371 Date: Aug. 16, 2024

(30) Foreign Application Priority Data
Feb. 18, 2022 (NZ) 785236

(51) Int. Cl. E04H 17/00; E04H 17/24

(52) U.S. Cl. CPC E04H 17/017; E04H 17/24

(57) ABSTRACT

A fence post for electric fencing is disclosed. The fence post has an elongate main body portion having a first end and a second end. The main body portion has a plurality of flanges extending along a longitudinal axis of the main body portion, and at least one of the flanges comprises a plurality of wire support features at predetermined locations along the length of the flange. The main body portion also has at least one mounting feature configured to assist in securing the fence post to a support member in use. The first end of the main body portion is configured as a plug, and the second end of the main body portion has a socket configured to receive a first end of another main body portion.

### STATEMENT OF CORRESPONDING APPLICATIONS

This application is based on the specification filed in relation to New Zealand Patent Application No. 785236, the entire contents of which are incorporated herein by reference.

### TECHNICAL FIELD

The present disclosure relates to a fence post for the support of wires, and more particularly for the addition of a fence top extension for security electric fences. The disclosure also relates to a fence post capable of extension by the connection of two or more fence post portions.

### BACKGROUND

Electric fencing is extensively used for security fencing. It is usually provided as an enclosure around the perimeter of a property to exclude intruders from the property to supply a safe and secure environment for both property and persons.

Electric security fences may be provided by setting up metal posts around the perimeter of an area and attaching insulators to the posts. Wires are then supported by the insulators to provide insulation from the metal post which is typically at ground potential and then the wires are tightened to a predetermined tension to provide a barrier against intruders. The wires are usually spaced apart at a distance that precludes an intruder from climbing between the wires, with spacing intervals of 60 mm or 70 mm or 90 mm typically used. The wires are then electrified by an electric fence energizer which provides a further deterrent against intruders because touching an electrified wire allows an electric current to pass through the person touching the electric fence which deters them from touching it any longer. The wires may also operate as an alarm system, by sensing the conditions of the wire an alarm may be triggered when there is an intruder attack against the fence.

Sometimes an existing barrier around a property may be a solid fence or wall made from concrete, blocks, bricks or any other material commonly used for making fences. It is often a requirement that an electric security fence be mounted on top of such a fence or on top of an existing wire fence to provide an extension in height of the fence and to provide an easily electrified section of fence.

South African Patent 96/9410 provides an insulating support member or post consisting of a rigid core element made from steel which is surrounded by plastic material which incorporates wire supports and provides an insulating barrier from the metal post. This product is heavy to transport and to install, and is not easy to configure in different lengths.

PCT application PCT/NZ2000/000104 discloses a plastic extrusion which has a hollow core which allows a steel rod to be inserted to provide an electric fence post that may be used in security fences.

Manufacturing and installing such fence posts as previously described can be labour intensive. Transporting many of such fence posts as previously disclosed are inefficient in both weight and volume. Installation of such fence posts as previously disclosed can be both labour intensive and difficult. When such fence posts suffer damage and require replacing this is both difficult and wasteful and expensive. Stocking fence posts of previously described fence posts require large inventories of stock to provide variety of length of fence posts and even then they have limited configuration options.

Aspects of the technology of the present disclosure are directed to overcoming one or more of the problems discussed above. It is an object of the present invention to address one or more of the foregoing problems or at least to provide the public with a useful choice.

Further aspects and advantages of the present disclosure will become apparent from the ensuing description which is given by way of example only.

### SUMMARY

A fence post for electric fencing, comprising:
an elongate main body portion having a first end and a second end, wherein the main body portion comprises:
   a plurality of flanges extending along a longitudinal axis of the main body portion,
   wherein at least one of the flanges comprises a plurality of wire support features at predetermined locations along the length of the flange,
   at least one mounting feature configured to assist in securing the fence post to a support member in use,
wherein the first end of the main body portion is configured as a plug, and the second end of the main body portion comprises a socket configured to receive a first end of another main body portion.

In examples the main body portion comprises, proximal at least one of the first end and the second end, a deformable feature configured to permit a limited degree of movement of the first end relative to the second end along the longitudinal axis of the main body portion.

In examples, the plurality of flanges comprises four flanges, and the deformable feature comprises a first slot extending through a first pair of adjacent flanges, and partially extending through a second pair of adjacent flanges. In examples, the deformable feature comprises a second slot extending through the second pair of adjacent flanges, and partially extending through the first pair of adjacent flanges.

In examples the socket and the plug are configured to permit mating in a single orientation. For example, the socket and the plug may have an asymmetrical shape. For example, one of the flanges may be configured to be radially longer than another of the flanges, and a cavity of the socket may be shaped to be complementary to this configuration.

In examples, the socket and the plug may comprise complementary locating features configured to interact to hold the socket and plug in place relative to each other. For example, at least one of the flanges may comprise a raised portion configured to be received in a recess or aperture of the socket.

In examples, the flanges at the first end may taper from a predetermined distance from the first end to the extremity of the first end. In examples cavities of the socket may be tapered to be a complementary fit with the taper of the flanges at the first end.

In examples the main body portion comprises at least one intermediary tapered portion at an intermediary position between the first end and the second end. In use, the main body portion may be cut at the intermediary tapered portion such that the intermediary tapered portion becomes a plug.

In examples each wire support feature is formed by a discontinuity in the at least one flange, comprising a first side of the discontinuity and a second side of the discontinuity, wherein an end of the first side of the discontinuity is radially offset from an end of the second side. In examples at least the first side of the discontinuity has a reverse curvature portion. In further examples both the first side of the discontinuity and the second side of the discontinuity have a reverse curvature portion. Reference to a reverse curvature should be understood to mean a shape in which a curve transitions to another curve in the opposite direction—occasionally referred to as an “S” curve. In examples, a similar shape may be achieved with angular transitions.

In examples the end of the first side of the discontinuity overlaps the end of the second side of the discontinuity along the longitudinal axis of the main body portion. In an example the end of the first side of the discontinuity and the end of the second side of the discontinuity each comprise a recess, wherein the recesses define an opening through which a wire may pass in use.

In examples the mounting feature is provided within 200 mm of the socket.

In examples the mounting feature comprises a tubular section protruding from the main body portion beyond the flanges. In examples the tubular section comprises a rim distal from the main body portion. In examples the rim comprises a first arc shaped recess and a second arc shaped recess provided on opposing sides of the rim. In an example, the radius of the first arc shaped recess is different to the radius of the second arc shaped recess.

In examples the main body portion may be secured directly to the support member in use. For example, the mounting feature may be seated against the support member, and a fastener such as a screw, set screw, split shank bolt (e.g. a Dynabolt), or nail used to secure the main body portion to the support member.

In examples a fastening device may be secured relative to the mounting feature, with the fastening device secured to the support member in use. In examples the fastening device may comprise an eye encircling the support member when installed. In an example the fastening device may include a hinged portion forming a portion of the eye, the hinged portion configured to be pivoted between an opening position and a closed position. In an alternative example the fastening device, comprising the eye, may be a unitary part. In examples a fastener may pass through the mounting feature to bear against a support member within the eye.

In examples, the main body portion comprises a tubular feature intersecting each of the plurality of flanges. In examples the tubular feature is provided proximal a centre of the main body between the first end and the second end.

In examples a longitudinal axis of the tubular feature is perpendicular to the longitudinal axis of the main body portion. In examples the tubular feature is cylindrical. In alternative examples the cross-section of the tubular feature may take other shapes, for example a square tube section.

In examples the main body portion is a unitary part. In examples the main body portion is moulded from an electrically insulating material. In examples the electrically insulating material is a plastics material.

In examples the length of the main body portion is no more than 800 mm.

The above and other features will become apparent from the following description and the attached drawings.

### BRIEF DESCRIPTION OF THE DRAWINGS

Further aspects of the present disclosure will become apparent from the following description which is given by way of example only and with reference to the accompanying drawings in which:

FIG. 1A is a perspective view of an exemplary fence post according to one aspect of the present technology.

FIG. 1B is another perspective view of the fence post.

FIG. 1C is a closeup view of a first end of the fence post.

FIG. 1D is a rotated closeup view of the first end of the fence post.

FIG. 1E is a closeup view of the second end of the fence post.

FIG. 2 is an isometric view of two fence posts lined up prior to engagement, with an enlarged view of the first end of one post and an enlarged view of the second end of the other post.

FIG. 3A is a partially rotated front view of a wire support section of a fence post.

FIG. 3B is a second partially rotated side view of the wire support section.

FIG. 3C is a side view of the wire support section.

FIG. 4A is an enlarged perspective view of a mounting feature of the fence post.

FIG. 4B is a perspective view of the mounting feature from a screw head fastening end.

FIG. 4C is a perspective view of the external post fastening end of the mounting feature.

FIG. 5 is a perspective view of three sections of fence post engaged together and mounted on a metal fence post.

FIG. 6 is a perspective view of an external post mounting rod post attachment bracket according to one aspect of the present technology.

FIG. 7 is a perspective view of another external post mounting rod post attachment bracket according to one aspect of the present technology.

FIG. 8 is a perspective view of a further external post mounting rod post attachment bracket according to one aspect of the present technology.

FIG. 9 is an end cross-sectional view of the fence post mounted to a rod supported by a steel security post according to one aspect of the present technology.

FIG. 10 is an end cross-sectional view of the fence post mounted to a rod according to one aspect of the present technology.

### DETAILED DESCRIPTION

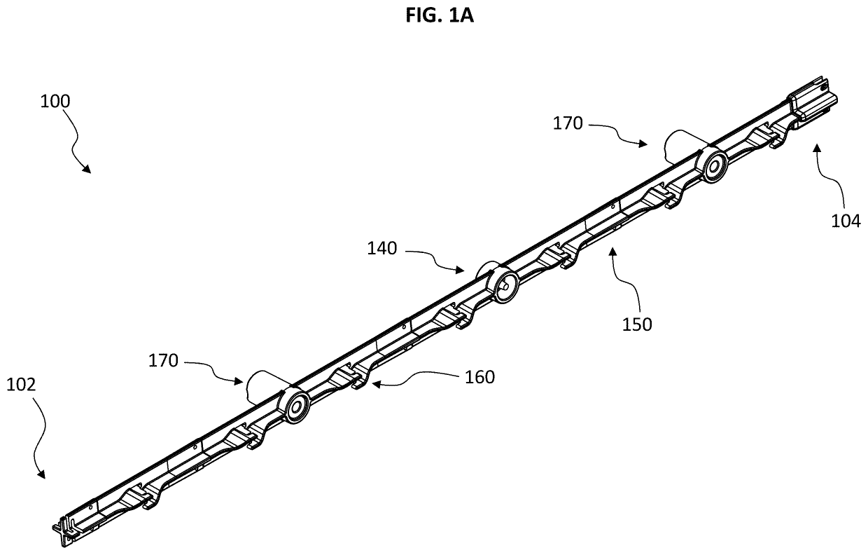

FIGS. 1A and 1B illustrate a fence post 100 according to one aspect of the present technology. In an exemplary embodiment, the fence post 100 is injection moulded as a unitary part from an insulating material such as high-density polyethylene or polypropylene or nylon. The fence post 100 has an elongate main body portion having a first end 102 and a second end 104. Referring to FIG. 1C, the fence post comprises four flanges (first flange 110, second flange 112, third flange 114, and fourth flange 116) that run substantially along the longitudinal axis of the post 100. Each flange is positioned at substantially 90 degrees rotation from the adjacent flange.

In this example, the main body portion comprises a tubular feature 140 intersecting each of the plurality of flanges 110, 112, 114, 116. In this example the tubular feature 140 is provided proximal a centre of the main body between the first end 102 and the second end 106. A longitudinal axis of the tubular feature 140 is perpendicular to the longitudinal axis of the main body portion. In the example illustrated the tubular feature 140 is cylindrical, but it should be appreciated that in alternative examples the cross-section of the tubular feature may take other shapes, for example a square tube section. The tubular feature assists in even distribution of material between the flanges during the molding of the post 100.

At least one of the flanges, in this example fourth flange 116, is a wire supporting flange which includes a plurality of wire support features 160, each adapted to support a wire. The wire may be electrified to provide an electric fence barrier which functions as both a deterrent and a detector against intruders. If an intruder touches the electrified wire they receive a shock which deters them from trying to climb through or over the wire. If the wire is cut or short circuited, a monitoring circuit detects the change in electric current or voltage which triggers an alarm which functions as an intruder detection.

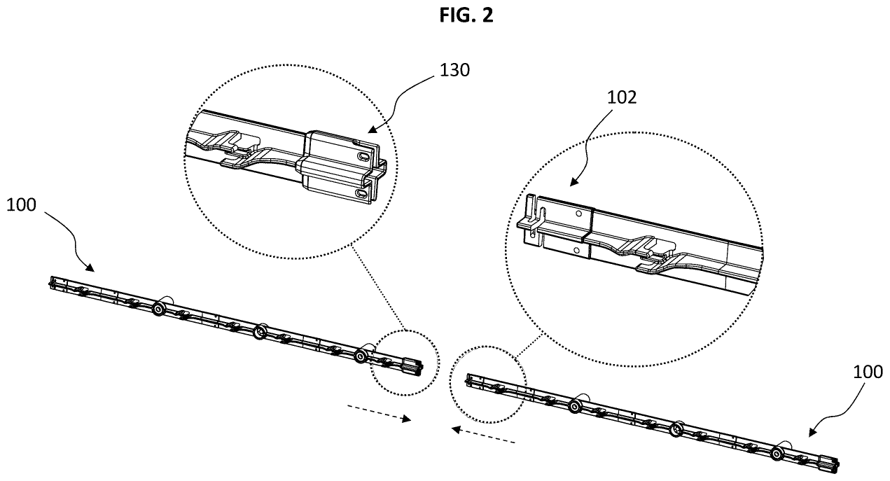

Referring to FIG. 1C, in this exemplary embodiment the first end 102 comprises a deformable feature 120 configured to permit a limited degree of movement of the first end 102 relative to the second end 104 along the longitudinal axis of the main body portion. In this example the deformable feature 120 comprises a first slot 122 extending through a first pair of adjacent flanges 110 and 112, and partially extending through a second pair of adjacent flanges 114 and 116, stopping short of the edge and leaving a small section of support material. The deformable feature further comprises a second slot 124 extending through the second pair of adjacent flanges 114 and 116, and partially extending through the first pair of adjacent flanges 110 and 112, again stopping short of the edge and leaving a small section of support material. It is envisaged that the distance from the extremity of the first end 102 to the first slot 122 may be in the order of 2 mm, although this is not intended to be limiting as other distances may be more suitable depending on the overall size of the post. It is further envisaged that the distance to the second slot 124 from the extremity of the first slot 122 may be in the order of 4 mm. This creates a bellows effect and allows the first end 102 of the post 100 to be deformed—essentially functioning as a spring when a compression force is applied along the length of the post 100. Such a compression force may be applied to the first end 102 when the first end 102 of one post 100 is inserted into the second end 104 of another post 100 (as will be described further below) then both posts 100 are attached to a rigid support structure such as a metal pipe post (see, for example pipe post 502 of FIG. 5). Each post 100 is attached to the metal pipe post 502 at one point. When increasing temperatures occur, the fence posts 100 will expand or elongate in the longitudinal direction along the post 100 and the deformable feature 120 at the first end 102 of the post 100 will compress to compensate for the thermal expansion. This compression prevents the posts 100 from distorting or buckling while being rigidly fixed at two points, one on each side of the connection 504 between the first end 102 and second end 104 of the respective posts.

Referring to FIG. 1D, the flanges at the first end 102 are each tapered along their length from a starting point 128, corresponding to a depth to which a socket 130 covers the first end 102 when two posts 100 are engaged with each other—as will be described further below. Referring to FIG. 1E, the socket 130 has a cavity complementary in shape to the first end 102, having a first cavity portion 132 receiving the first flange 110, a second cavity portion 134 receiving the second flange 112, a third cavity portion receiving the third flange 114, and a fourth cavity portion 134 receiving the fourth flange 116. The cavity of the socket 130 is also tapered along the same length within the socket, so that when the first end 102 (herein referred to as the “plug”) is inserted into the socket 130, they fit snugly along their length to reduce lateral movement within the socket 130.

In this example the socket 130 and the plug 102 comprise complementary locating features configured to interact to hold the socket 130 and plug 102 in place relative to each other. For example, the first flange 110 and third flange 114 comprise raised portions or bumps 126 configured to be received in a recess or aperture 139 of the first cavity portion 132 and the third cavity portion 136 of the socket 130. It is envisaged that this may be particularly useful in securing the connection prior to installation to an external mounting structure.

In this example radial distance across the flanges (e.g. first flange 110 and third flange 114) in one direction is greater than the distance across the flanges at right angles to them (e.g. second flange 112 and fourth flange 116). This means that the plug end 102 of one fence post 100 cannot be inserted in the socket 130 of another fence post 100 rotated 90 degrees from the correct orientation. Alternatively, the thickness of the first flange 110 and third flange 114 could be different to that of the second flange 112 and fourth flange 116. In examples, at least one flange has a thicker cross section than the other flange on the same radial axis (i.e. the opposing flange). This prevents a post 100 from being incorrectly inserted at 180 degrees from the correct orientation; the correct orientation of connected fence posts 100 being when flanges having the wire support features 160 of both posts 100 are aligned along the same line.

As shown in FIG. 1A and 1B, the fence post 100 also include some first end features periodically along the post at intermediary points 150. The post 100 may be cut at these points 150 to create a new end but without the deformable feature 120 (which is not required for a shortened combined post). The periodic features still include, for example the taper, the flange radial length/thicknesses, and the securing bumps 126.

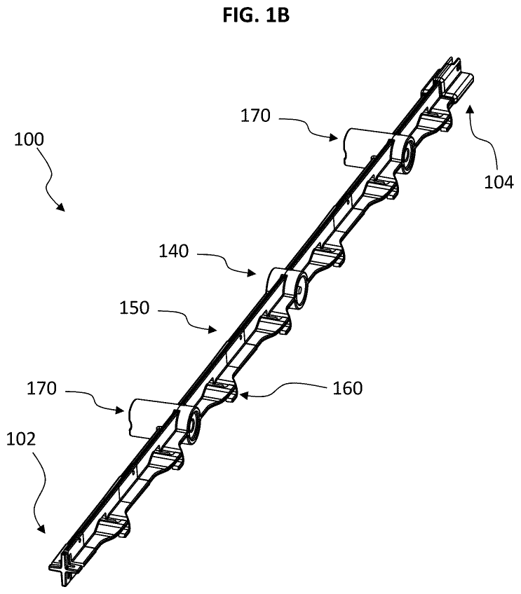

Referring to FIG. 2, two fence posts 100 may be connected together by inserting the plug end 102 of one post 100 into the socket 130 of the other post. By plugging fence posts together a variety of different lengths of post can be created, while still providing a fence post suitably sized for efficient shipping and handling. In exemplary embodiments each fence post may be between 600 mm and 800 mm long, more preferably about 600 mm long. However, it should be appreciated that this is not intended to be limiting, and that alternate lengths may be provided.

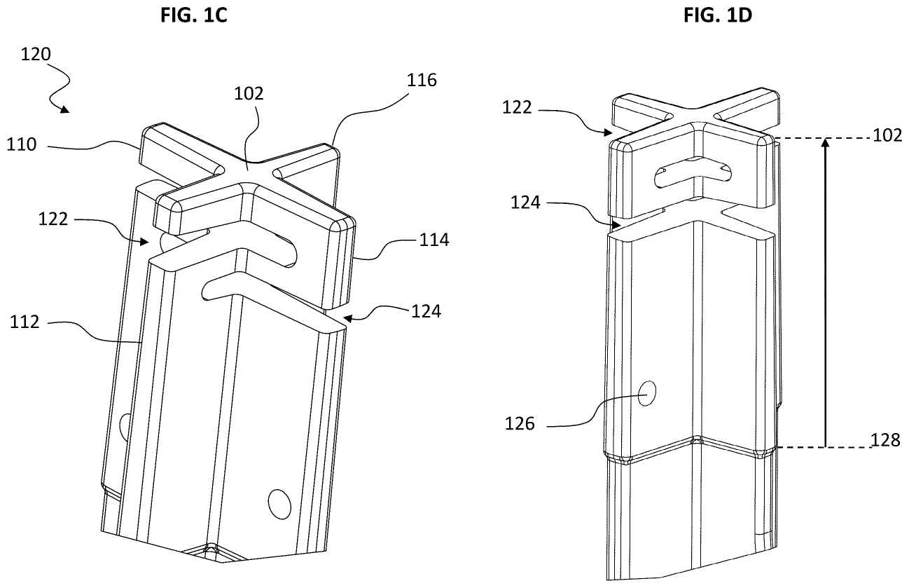

Referring to FIGS. 3A to 3C, in this example the wire support feature 160 is formed by creating a discontinuity in the wire supporting flange 116. The wire support feature 160 comprises a first side 161 of the discontinuity and a second side 162 of the discontinuity, wherein an end 162 of the first side 161 is radially offset from an end 164 of the second side 163. In examples the first side 161 and the second side 163 each have a reverse curvature portion which produces the radial offset. The end 162 of the first side 161 overlaps the end 164 of the second side 163 along the longitudinal axis of the main body portion. The respective ends 162 and 164 each comprise a recess 166 and 167, wherein the recesses 166 and 167 define an opening 169 through which a wire may pass in use.

The wire is also supported within the opening 169 by a raised wire positioning feature 168 that also functions to give increased strength to the post 100 at the discontinuity. The raised wire positioning feature 168 also guides the wire to a position a predetermined distance away from the external support structure (e.g. pipe post 502) to which the post 100 is attached. This provides further clearance and creepage distance against the leakage of electric current from the wire when electrified, to the grounded external support structure.

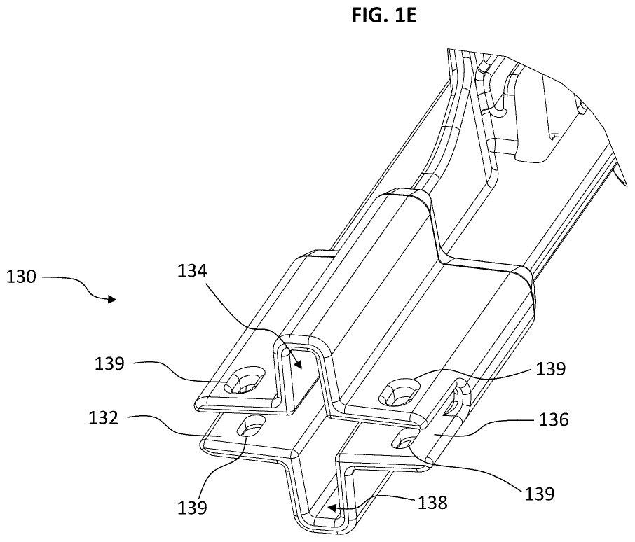

Each fence post comprises a mounting feature 170 configured to assist in securing the fence post to an external support member in use. Referring to FIG. 4A to 4C, the mounting feature 170 comprises a main tubular section 172 protruding from the main body portion beyond the flanges, having a rim 174 distal from the main body portion. The mounting feature 170 further comprises an internal fastener guide 176 defining a fastener aperture 178. In use, to attach the fence post 100 to an external structure, such as a metal post, a hole is drilled in the metal post at the fixing point and a fastener such as a screw or self-drilling style screw is passed through the fastener aperture 178 and screwed into the post. A second section of fence post may subsequently be engaged with a first section, but it is expected that these sections would normally connected together before attaching to post—see for example, FIG. 5. Referring to FIG. 4B, a flat recessed portion 180 provides a seat for the head of a fastener. As shown in FIG. 4C, the rim 174 comprises a first arc shaped recess 182 and a second arc shaped recess 184 on opposing sides of the rim 174. These arc shaped recesses function to locate against the circumference of a rod or pipe to which the post may be attached to prevent rotation. This prevents rotation at the arc to pipe or rod interface when the fence post is being fixed to the metal pipe with a fixing device such as a screw. In examples, the radius of the first arc shaped recess is different to the radius of the second arc shaped recess, so that the mounting feature 174 can securely locate on different diameter post, pipes or rods.

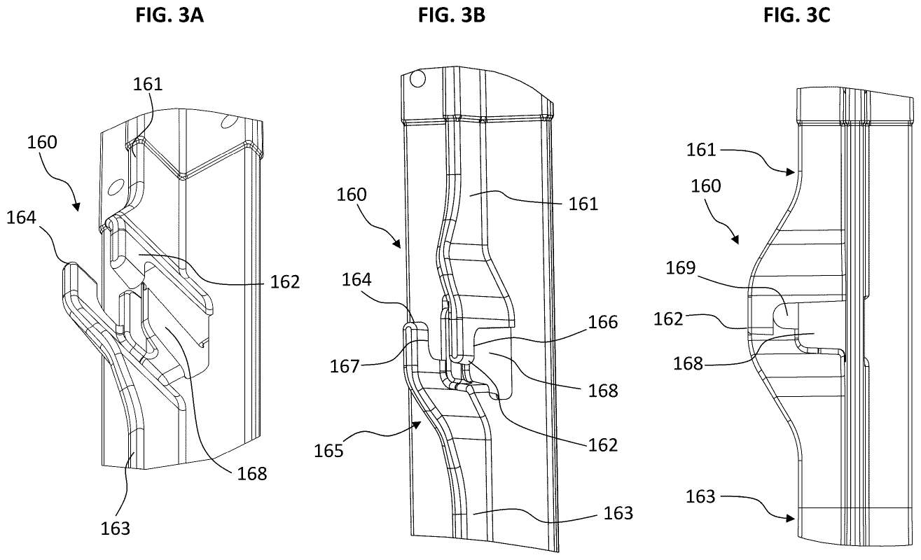

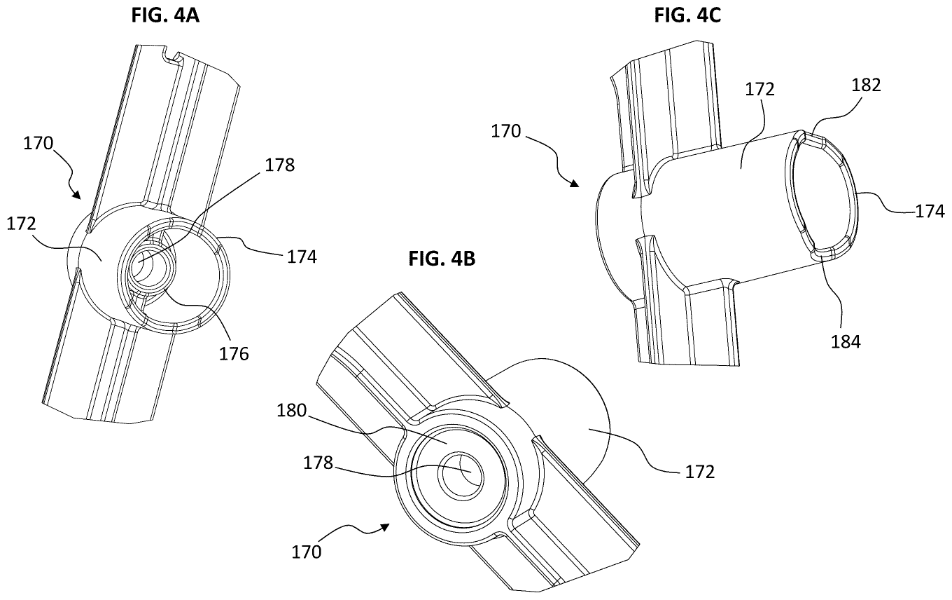

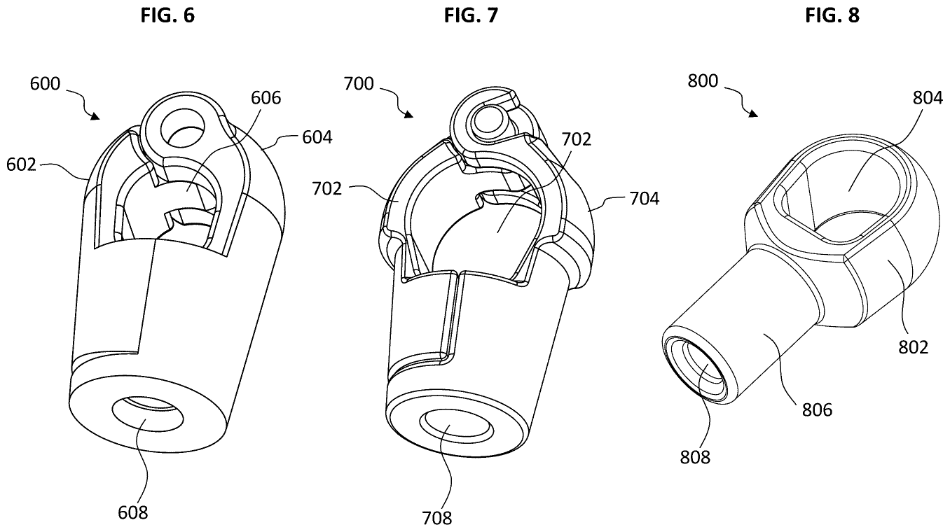

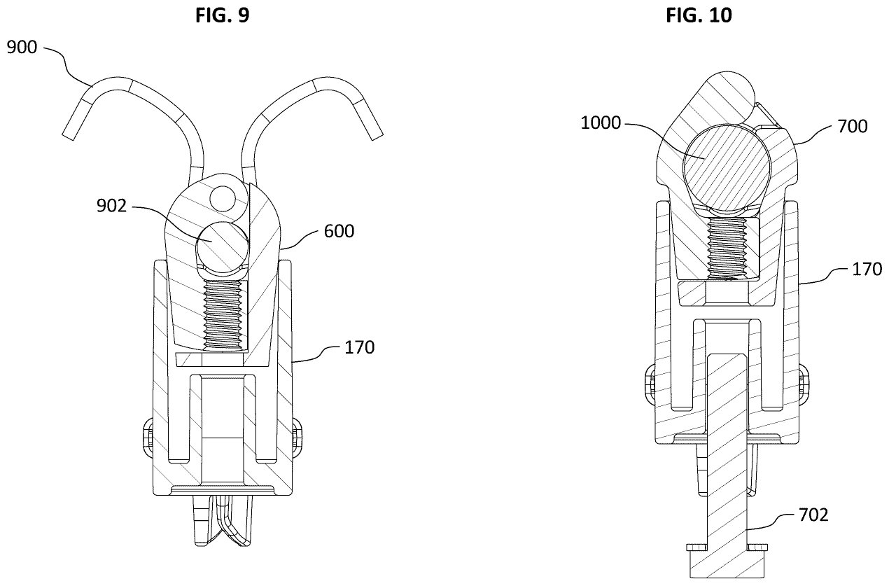

In an alternative arrangement, a fastening device may be secured relative to the mounting feature 170, with the fastening device secured to the support member in use. FIG. 6 shows an exemplary fastening device 600 comprising a first hinged portion 602 and a second hinged portion 604, defining an eye 606 configured to encircle the support member when installed. The hinged portions 602 are configured to be pivoted relative to each other between an open position and a closed position, such that the fastening device 600 may be opened, positioned around the support member, and then closed. The fastening device 600 further comprises a fastener bore 608 including a threaded section, into which a fastener such as a machine setscrew may be inserted (see, e.g., the setscrew 702 shown in FIG. 10). FIG. 9 illustrates an installation utilising the fastening device 600, in which the hinged fastening device 600 is closed around an external mounting structure in the form of a rod 900 (e.g. made of a metal or fibreglass) supported by a steel security fence post 900, and secured to the mounting feature 170. FIG. 7 shows an alternative hinged fastening device 700 generally configured in the manner of fastening device 600, with FIG. 10 showing the hinged fastening device 700 closed around a support rod 1000.

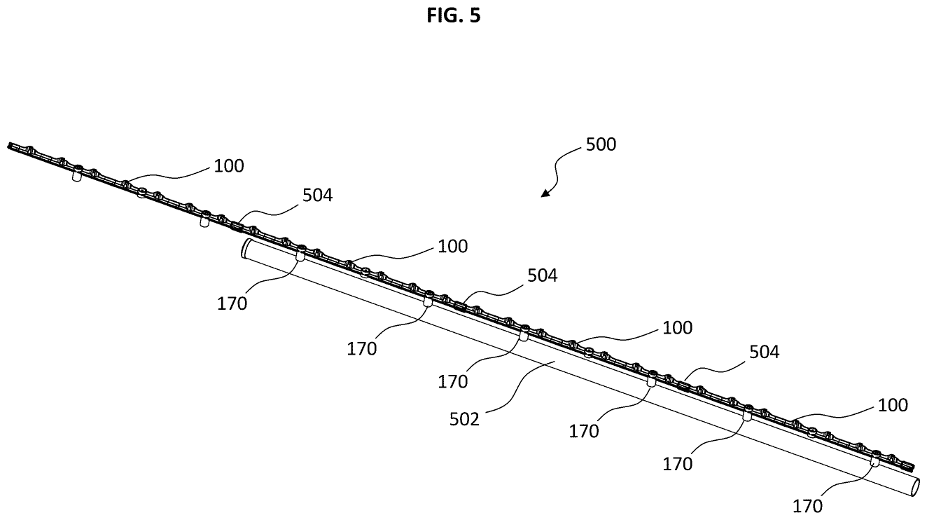

In an alternative example, as shown in FIG. 8, the fastening device 800, comprising a head 802 having an eye 804 and a barrel portion 806 having a fastener bore 808, may be a unitary part. With this configuration the device fastening device 800 is placed over top of the rod through the eye 804 in the device and then positioned at a desired location on the rod. When the machine set screw is inserted in the threaded section of the fastening device it may extend through the threaded section and bear up against the support member (e.g. the rod) and so prevent the fastening device together with the fence post from sliding along the support member or rod when in use.

The fastening devices may be die-cast metal, preferably aluminium or zinc, or it may be injection moulded from a suitable plastic such as nylon or glass filled nylon.

The external mounting structure may be a steel rod or a fibreglass rod, or a steel post or a concrete block or concrete slab wall or any structure that traditionally provides a physical barrier between two spaces.

The illustrated embodiments of the disclosure will be best understood by reference to the figures. The foregoing description is intended only by way of example and simply illustrates certain selected exemplary embodiments of the disclosure.

The entire disclosures of all applications, patents and publications cited above and below, if any, are herein incorporated by reference. Reference to any prior art in this specification is not, and should not be taken as, an acknowledgement or any form of suggestion that that prior art forms part of the common general knowledge in the field of endeavour in any country in the world.

The invention(s) of the present disclosure may also be said broadly to consist in the parts, elements and features referred to or indicated in the specification of the application, individually or collectively, in any or all combinations of two or more of said parts, elements or features. Where in the foregoing description reference has been made to integers or components having known equivalents thereof, those integers are herein incorporated as if individually set forth.

Furthermore, the described features, structures, or characteristics may be combined in any suitable manner in at least one embodiment. In the foregoing description, numerous specific details are provided to give a thorough understanding of the exemplary embodiments. One skilled in the relevant art may well recognize, however, that embodiments of the disclosure can be practiced without at least one of the specific details thereof, or can be practiced with other methods, components, materials, et cetera. In other instances, well-known structures, materials, or operations are not shown or described in detail to avoid obscuring aspects of the invention.

Throughout this specification, the word “comprise” or “include”, or variations thereof such as “comprises”, “includes”, “comprising” or “including” will be understood to imply the inclusion of a stated element, integer or step, or group of elements integers or steps, but not the exclusion of any other element, integer or step, or group of elements, integers or steps, that is to say, in the sense of “including, but not limited to”.

Aspects of the present disclosure have been described by way of example only and it should be appreciated that modifications and additions may be made thereto without departing from the scope thereof as defined in the appended claims.

1. A fence post for electric fencing, comprising:
an elongate main body portion having a first end and a second end, wherein the main body portion comprises:
a plurality of flanges extending along a longitudinal axis of the main body portion,
wherein at least one of the flanges comprises a plurality of wire support features at predetermined locations along the length of the flange,
at least one mounting feature configured to assist in securing the fence post to a support member in use,
wherein the first end of the main body portion is configured as a plug, and the second end of the main body portion comprises a socket configured to receive a first end of another main body portion.

2. The fence post of claim 1, wherein the main body portion comprises, proximal at least one of the first end and the second end, a deformable feature configured to permit a limited degree of movement of the first end relative to the second end along the longitudinal axis of the main body portion.

3. The fence post of claim 2, wherein the plurality of flanges comprises four flanges, and the deformable feature comprises a first slot extending through a first pair of adjacent flanges, and partially extending through a second pair of adjacent flanges.

4. The fence post of claim 3, wherein the deformable feature comprises a second slot extending through the second pair of adjacent flanges, and partially extending through the first pair of adjacent flanges.

5. The fence post of claim 1, wherein the socket and the plug are configured to permit mating in a single orientation.

6. The fence post of claim 6, wherein the socket and the plug have an asymmetrical shape.

7. The fence post of claim 1, wherein the socket and the plug comprise complementary locating features configured to interact to hold the socket and plug in place relative to each other.

8. The fence post of claim 1, wherein the flanges at the first end taper from a predetermined distance from the first end to the extremity of the first end, and cavities of the socket are tapered to be a complementary fit with the taper of the flanges of at the first end.

9. The fence post of claim 1, wherein the main body portion comprises at least one intermediary tapered portion at an intermediary position between the first end and the second end.

10. The fence post of claim 1, wherein each wire support feature is formed by a discontinuity in the at least one flange, comprising a first side of the discontinuity and a second side of the discontinuity, wherein an end of the first side is radially offset from an end of the second side.

11. The fence post of claim 10, comprising at least one selected from the group consisting of:
at least the first side of the discontinuity has a reverse curvature portion;
both the first side of the discontinuity and the second side of the discontinuity have a reverse curvature portion;
the end of the first side of the discontinuity overlaps the end of the second side of the discontinuity along the longitudinal axis of the main body portion;
the end of the first side of the discontinuity and the end of the second side of the discontinuity each comprise a recess, wherein the recesses define an opening through which a wire may pass in use.

12-15. (canceled)

16. The fence post of claim 1, wherein the at least one mounting feature comprises a tubular section protruding from the main body portion beyond the flanges.

17. The fence post of claim 16, wherein the tubular section comprises a rim distal from the main body portion, wherein the rim comprises a first arc shaped recess and a second arc shaped recess provided on opposing sides of the rim, and the radius of the first arc shaped recess is different to the radius of the second arc shaped recess.

18. (canceled)

19. The fence post of claim 1, wherein the main body portion comprises a tubular feature intersecting each of the plurality of flanges.

20. The fence post of claim 19, wherein the tubular feature is provided proximal a centre of the main body between the first end and the second end.

21. The fence post of claim 19, wherein a longitudinal axis of the tubular feature is perpendicular to the longitudinal axis of the main body portion.

22. An assembly for electric fencing, comprising:
a support member; and
a fence post, comprising:
an elongate main body portion having a first end and a second end, wherein the main body portion comprises:
a plurality of flanges extending along a longitudinal axis of the main body portion,
wherein at least one of the flanges comprises a plurality of wire support features at predetermined locations along the length of the flange,
at least one mounting feature configured to assist in securing the fence post to a support member in use,
wherein the first end of the main body portion is configured as a plug, and the second end of the main body portion comprises a socket configured to receive a first end of another main body portion; and
wherein the fence post is secured relative to the support member in use.

23. The assembly of claim 22, comprising a fastening device secured to the mounting feature, with the fastening device securing the support member relative to the mounting feature in use.

24. The assembly of claim 23, the fastening device comprises an eye, configured to encircle the support member in use.

25. The assembly of claim 24, wherein the fastening device comprises a hinged portion forming a portion of the eye, the hinged portion configured to be pivoted between an opening position and a closed position.
